(19) United States
(12) Patent Application Publication
(10) Pub. No.: US 2002/0154519 A1
(43) Pub. Date: Oct. 24, 2002

(54) Control apparatus for DC/DC converter

(76) Inventors: Kazuhiro Nakahara, Saitama (JP); Koichi Ueki, Saitama (JP); Fumito Takahashi, Saitama (JP); Takayuki Usuda, Saitama (JP)

Correspondence Address: STAAS & HALSEY LLP, 700 11TH STREET, NW, SUITE 500, WASHINGTON, DC, 20001, US

(21) Appl. No.: 10/105,617

(22) Filed: Mar. 26, 2002

(30) Foreign Application Priority Data
Mar. 26, 2001 (JP) 2001-087555

(51) Int. Cl. H02M 3/335

(52) U.S. Cl. 363/20

(57) ABSTRACT

A control apparatus controlling a DC/DC converter. The control apparatus switches on and off switching devices to transfer the electric power from a main storage battery to an auxiliary battery. The control apparatus includes a control circuit controlling the switching on and off, a voltage monitor detecting the over and under voltage of the main storage battery, and a gate drive circuit, including a driving transformer, driving the switching devices. The control apparatus utilizes the large current, which flows on the control circuit side of the driving transformer by short-circuiting the output side of the transformer in response to the detected over or under voltage, to transfer the isolated signal indicating the main storage battery voltage to the control circuit side. The control apparatus is more reliable than conventional control apparatuses, which employ a photo-coupler to transfer the isolated signal to the control circuit side.

### CROSS REFERENCE TO RELATED APPLICATIONS

This application claims the benefit of Japanese application no. 2001-087555, filed Mar. 26, 2001, the disclosure of which is incorporated herein by reference.

### BACKGROUND OF THE INVENTION

1. Field of the Invention

The present invention relates to a control apparatus for a DC/DC converter that transfers electric power from a main storage battery to an auxiliary storage battery. In particular, the present invention provides a control apparatus for controlling a DC/DC converter, used for electric vehicles, that transfers signals indicating an over voltage and an under voltage of the main storage battery to the control side of the DC/DC converter.

2. Description of the Related Art

FIG. 8 is a block circuit diagram of a first conventional DC/DC converter. FIG. 9 is a block circuit diagram of a second conventional DC/DC converter.

Referring now to FIG. 8, the first conventional DC/DC converter includes an auxiliary storage battery 1, a main storage battery 2, a control circuit 3, a photo-coupler 4, a gate drive circuit 5, a voltage monitor 7, field effect transistors (MOSFET's) working as switching devices Q1 and Q2, and diodes D1 and D2. Referring now to FIG. 9, the second conventional DC/DC converter includes an auxiliary storage battery 1, a main storage battery 2, a control circuit 3, a photo-coupler 4, a gate drive circuit 5, a voltage monitor 7, and a field effect transistor (MOSFET) working as a switching device Q1. The first DC/DC converter shown in FIG. 8 switches on and off the switching devices Q1 and Q2 to transfer electric power from the main storage battery 2 to the auxiliary storage battery 1. The second DC/DC converter shown in FIG. 9 switches on and off the switching device Q1 to transfer electric power from the main storage battery 2 to the auxiliary storage battery 1.

Considering just the DC/DC converter, there is no problem regardless of whether the control circuit 3 is coupled to the potential of the main storage battery 2 or to the potential of the auxiliary storage battery 1. However, when the DC/DC converter is mounted on a vehicle, the negative electrode of the auxiliary storage battery 1, which has a voltage of 12 V, is connected to the body of the vehicle. Therefore, it is necessary for the control circuit 3 of the DC/DC converter to exchange signals with the engine control unit (ECU) and other such control circuits of the vehicle with reference to the body potential of the vehicle. Therefore, the control circuit 3 of the DC/DC converter is coupled to the potential of the auxiliary storage battery 1. The potential of the main storage battery 2 is floated with respect to the potential of the auxiliary storage battery 1 to prevent electric power and noise from the side of the auxiliary battery 1 from leaking to the main storage battery 2.

For preventing devices such as switching devices Q1, Q2 and the diodes D1, D2 in the configuration as described above from being broken down by the voltage applied thereto, which is higher than the respective breakdown voltages, it is necessary to stop the control of the DC/DC converter when the voltage of the main storage battery 2 is too high. The control of the DC/DC converter is also stopped when the voltage of the main storage battery 2 is too low, since the reference voltage is not obtained. Therefore, it is necessary to transmit the over voltage and the under voltage of the main storage battery 2 to the control side of the DC/DC converter, which is isolated from the side of the DC/DC converter having the main storage battery 2.

The DC/DC converters shown in FIGS. 8 and 9 include the photo-coupler 4 for transmitting the signal indicating the over voltage and the under voltage of the main storage battery 2 to the control side.

The transfer efficiency of the photo-coupler 4 in the on-vehicle power supply used under severe environmental conditions quickly decreases due to age deterioration. The photo-coupler 4 sometimes fails to transfer the signals indicating the over voltage and the under voltage of the main storage battery 2 to the control side due to the variations of the characteristics of the constituent elements.

In view of the foregoing, it is an object of the present invention to provide a control device for controlling a DC/DC converter, which reliably transfers signals indicating the over voltage and the under voltage of the main storage battery 2 to the control side.

### SUMMARY OF THE INVENTION

According to a first aspect of the invention, there is provided a control apparatus for controlling a DC/DC converter including one or more switching devices, the DC/DC converter transferring electric power to a first electric power supply from a second electric power supply. The control apparatus includes the following: a control circuit arranged on the side of the first electric power supply; a gate drive circuit including a driving transformer and a voltage monitor, the voltage monitor monitoring the voltage of the second electric power supply; the control circuit driving the primary side of the driving transformer to induce a voltage on the secondary side of the driving transformer, the driving transformer driving the one or more switching devices arranged on the side of the second electric power supply with an induced voltage isolated from the control circuit; the voltage monitor outputting a signal for short-circuiting the secondary side of the driving transformer when the voltage of the second electric power supply is outside a predetermined range to make a large current flow on the primary side of the driving transformer; the control circuit detecting the large current flowing on the primary side of the driving transformer to detect the voltage of the second electric power supply outside the predetermined range on the side of the control circuit.

Advantageously, the secondary side of the driving transformer includes a plurality of windings and a short-circuiting circuit connected to one of the windings.

Advantageously, the secondary side of the driving transformer includes a plurality of windings and short-circuiting circuits connected to the respective windings.

Advantageously, the secondary side of the driving transformer includes a plurality of windings, a short-circuiting circuit connected to one of the windings, and one or more additional circuits connected to the other winding or the other windings, the one or more additional circuits not feeding driving electric power to the corresponding one or more switching devices when the voltage induced in the other winding is low or when the voltages induced in the other windings are low.

According to a second aspect of the invention, there is provided a control apparatus for controlling a DC/DC converter including switching devices, the DC/DC converter transferring electric power to a first electric power supply from a second electric power supply. The control apparatus includes the following: a control circuit arranged on the side of the first electric power supply; a gate drive circuit including a plurality of driving transformers and a voltage monitor, the voltage monitor monitoring the voltage of the second electric power supply; the control circuit driving the primary sides of the respective driving transformers to induce voltages on the secondary sides of the respective driving transformers, the driving transformers driving the respective switching devices arranged on the side of the second electric power supply with the induced voltages isolated from the control circuit; the voltage monitor outputting a signal for short-circuiting the secondary side of one of the driving transformers when the voltage of the second electric power supply is outside a predetermined range to make a large current flow on the primary side of the one of the driving transformers, the secondary side thereof being shortcircuited; the control circuit detecting the large current flowing on the primary side of the one of the driving transformers to detect the voltage of the second electric power supply outside the predetermined range on the side of the control circuit.

According to a third aspect of the invention, there is provided a control apparatus for controlling a DC/DC converter including switching devices, the DC/DC converter transferring electric power to a first electric power supply from a second electric power supply. The control apparatus includes the following: a control circuit arranged on the side of the first electric power supply; a gate drive circuit including a plurality of driving transformers and a voltage monitor, the voltage monitor monitoring the voltage of the second electric power supply; the control circuit driving the primary sides of the respective driving transformers to induce voltages on the secondary sides of the respective driving transformers, the driving transformers driving the respective switching devices arranged on the side of the second electric power supply with the induced voltages isolated from the control circuit; the voltage monitor outputting a signal for short-circuiting the secondary sides of the respective driving transformers when the voltage of the second electric power supply is outside a predetermined range to make large currents flow on the primary sides of the respective driving transformers, the secondary sides thereof being short circuited; the control circuit detecting the large current flowing on the primary side of one of the driving transformers to detect the voltage of the second electric power supply outside the predetermined range on the side of the control circuit.

Advantageously, the control apparatus further includes a latch circuit which latches the signal indicating the detection of the voltage of the second electric power supply outside the predetermined range.

Advantageously, the control circuit stops the converting operation of the DC/DC converter when the voltage of the second electric power supply outside the predetermined range is detected.

These, together with other aspects and advantages that will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block circuit diagram of a DC/DC converter according to a first embodiment of the invention.

FIG. 2 is a block circuit diagram of the gate drive circuit used in the DC/DC converter according to the first embodiment of the invention.

FIG. 3 is a circuit diagram of the voltage monitor used in the DC/DC converter according to the first embodiment of the invention.

FIG. 4 is a block circuit diagram of a gate drive circuit according to a second embodiment of the invention.

FIG. 5 is a block circuit diagram of a gate drive circuit according to a third embodiment of the invention.

FIG. 6 is a circuit diagram of a voltage monitor used for the gate drive circuit shown in FIG. 5.

FIG. 7 is a block circuit diagram of a gate drive circuit according to a fourth embodiment of the invention.

FIG. 8 is a block circuit diagram of a first conventional DC/DC converter.

FIG. 9 is a block circuit diagram of a second conventional DC/DC converter.

### DETAILED DESCRIPTION OF THE PREFERRED EMBODIMENTS

Now the invention will be explained in detail hereinafter with reference to the accompanying drawings which illustrate the preferred embodiments of the invention.

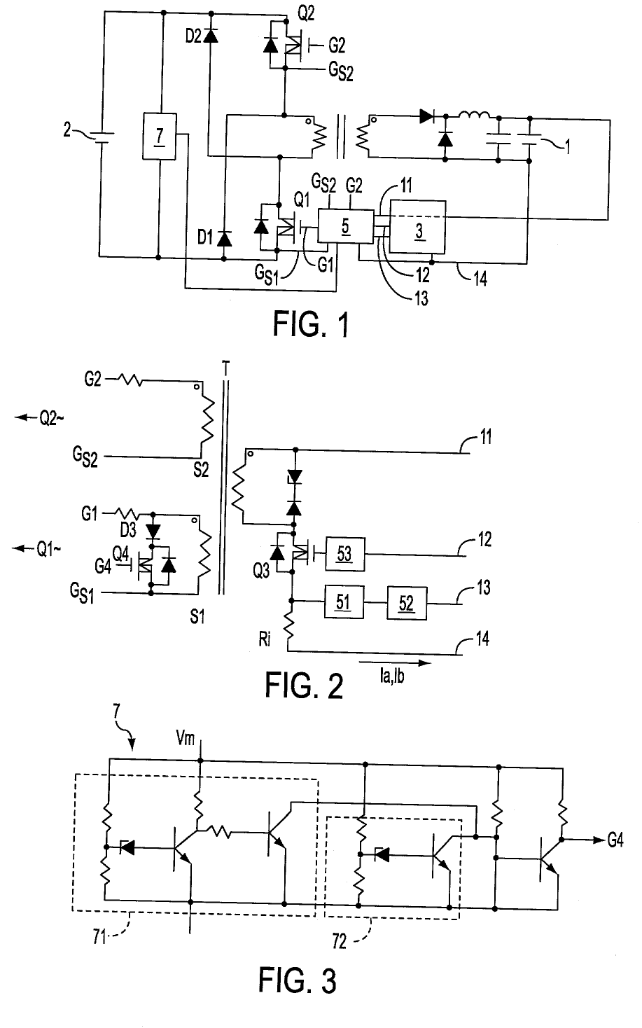

FIG. 1 is a block circuit diagram of a DC/DC converter according to a first embodiment of the invention. FIG. 2 is a block circuit diagram of the gate drive circuit used in the DC/DC converter according to the first embodiment of the invention. FIG. 3 is a circuit diagram of the voltage monitor used in the DC/DC converter according to the first embodiment of the invention.

Referring now to FIG. 1, the DC/DC converter according to the first embodiment of the invention does not include the photo-coupler used for the conventional DC/DC converters shown in FIGS. 8 and 9. Referring now to FIG. 2, the gate drive circuit 5 for the DC/DC converter according to the first embodiment includes a current detector Ri, a comparator 51, a latch circuit 52, a switching device Q3, and a gate driver 53.

Referring now to FIG. 3, the voltage monitor 7 for monitoring the state of the voltage Vm of the main storage battery 2 includes an under voltage detecting section 71 and an over voltage detecting section 72. The voltage monitor 7 outputs an output G4 at a low level (hereinafter referred to as an “L-level”) when the voltage Vm is within a proper range to make a switching device Q4 in FIG. 2 open. The voltage monitor 7 outputs an output G4 at a high level (hereinafter referred to as a “H-level”) when the voltage Vm is outside the proper range, that is when the voltage Vm is an over voltage or an under voltage, to short-circuit the switching device Q4 in FIG. 2.

When the voltage Vm is within the proper range, the current of the driving transformer on the control side in FIG. 1 converges to a small value la after the gate current feed has finished. The current detector Ri detects the voltage Va=Ri×la. When the voltage Vm is an over voltage or an under voltage, the secondary winding S1 of the driving transformer is short-circuited by the switching device Q4. Therefore, the current of the driving transformer takes a large value lb transiently, and the current detector Ri detects the voltage Vb=Ri×lb. Thus, the state of the voltage Vm of the main storage battery 2 is detected on the control side by setting the reference value Vs of the comparator 51 such that Va<Vs<Vb.

As the primary side of the driving transformer is driven, a little voltage is induced in the secondary winding S2 even when the secondary winding S1 is short-circuited. By employing a MOSFET, the gate voltage thereof being higher than the induced voltage, for the switching device Q2, it becomes unnecessary to add a specific circuit to the gate drive circuit on the side of the secondary winding S2 to prevent switching device Q2 from being controlled to switch on if the voltage induced in secondary winding S2 exceeds the threshold voltage of Q2. When an appropriate MOSFET is not found, an appropriate additional circuit is provided to the gate drive circuit on the side of the secondary winding S2.

The latch circuit 52 is formed, for example, of a flip-flop. When the comparator 51 detects an over voltage or an under voltage, the latch circuit 52 latches the over voltage or the under voltage. In the power supply as described above, the gate driver 53 usually feeds gate drive signals to the switching device Q3 to make the switching device Q3 repeat switching on and off in a short time. Even when the secondary side of the driving transformer is short-circuited, the driving current from the driving transformer quickly decreases, although the driving current increases transiently. Therefore, there remains a certain possibility that the over voltage and the under voltage of the voltage Vm is not detected at a proper time. The latch circuit 52 is disposed to detect the over voltage and the under voltage of the voltage Vm without fail. By stopping the control of the DC/DC converter as soon as the latch circuit 52 works, the control of the DC/DC converter is stopped at the drive thereof immediately after an over voltage or an under voltage occurs.

For confirming on the control side whether the over voltage state or the under voltage state is continuing or not, the latched state of the latch circuit 52 is reset to return the control of the DC/DC converter to the driving state again. If the over voltage state or the under voltage state is still continuing, a voltage exceeding the reference value Vs is detected again on the control side, since the short-circuit of the switching device Q4 is continuing, and the control of the DC/DC converter is stopped. Since any drive signal is not fed to the switching devices Q1 and Q2 in this occasion, the switching devices Q1 and Q2 keep the OFF-state thereof. Therefore, it is not necessary to consider the fault of the switching devices Q1 and Q2 caused by the surge voltage generated when the switching devices Q1 and Q2 switch from the ON-state to the OFF-state thereof. Since the latch circuit 52 does not work after the voltage Vm has returned to the proper range, the driving control of the DC/DC converter is resumed.

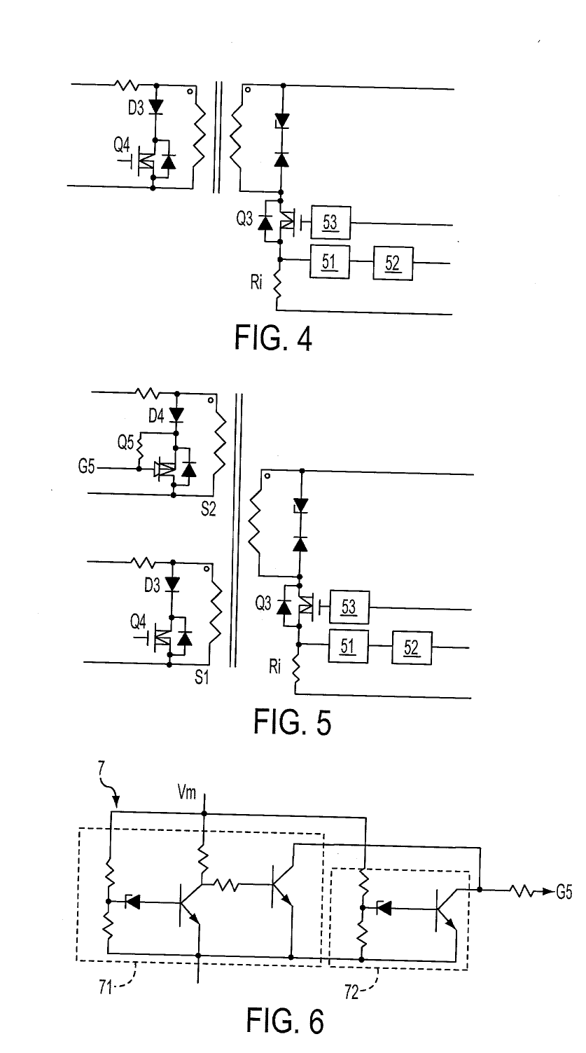

FIG. 4 is a block circuit diagram of a gate drive circuit according to a second embodiment of the invention. The gate drive circuit according to the second embodiment is used for the DC/DC converter, which is configured as shown in FIG. 9. Since the gate drive circuit according to the second embodiment is different from the gate drive circuit shown in FIG. 2 only in that the gate drive circuit in FIG. 4 does not include the secondary winding S2, the descriptions of the gate drive circuit according to the second embodiment are omitted.

FIG. 5 is a block circuit diagram of a gate drive circuit according to a third embodiment of the invention. The gate drive circuit shown in FIG. 5 is used for the DC/DC converter shown in FIG. 1. FIG. 6 is a circuit diagram of a voltage monitor used for the gate drive circuit shown in FIG. 5.

Referring now to FIG. 5, the gate drive circuit according to the third embodiment includes a switching element Q5 disposed on the side of the secondary winding S2 of the driving transformer shown in FIG. 2. The circuit including the switching element Q5 is an additional circuit, which considers the case in which a voltage high enough to drive the switching device Q2 is induced in the secondary winding S2, even when the secondary winding S1 is short-circuited under the state of over voltage and under the state of under voltage. In the configuration as shown in FIG. 5, the secondary winding S2 is also short-circuited by the output G5 from the voltage monitor shown in FIG. 6 when an over voltage or an under voltage occurs. Switching element Q4 in FIG. 5 is controlled by the control signal G4 output from the voltage monitor 7 of FIG. 3, whereas switching element Q5 in FIG. 5 is controlled by the control signal G5 output from the voltage monitor 7 of FIG. 6.

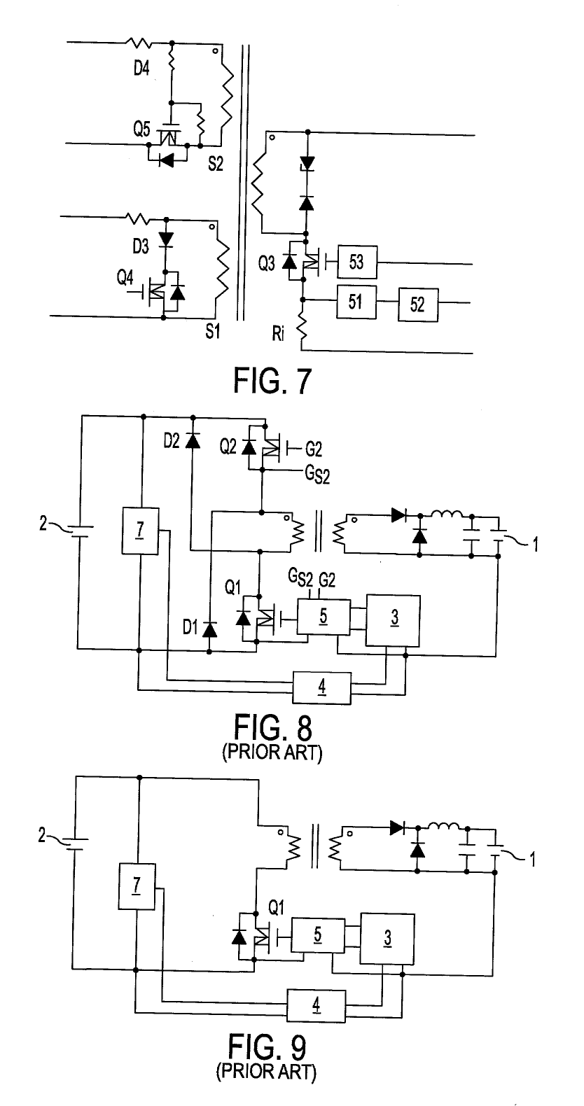

FIG. 7 is a block circuit diagram of a gate drive circuit according to a fourth embodiment of the invention.

The gate drive circuit according to the fourth embodiment considers the voltage induced in the secondary winding S2.

Generally, the voltage induced in the secondary winding S2 when the switching device Q4 is open-circuited is higher than the voltage induced in the secondary winding S2 when the switching device Q4 is closed. The gate drive circuit according to the fourth embodiment of the invention utilizes the magnitude of the induced voltage. In detail, the gate drive circuit according to the fourth embodiment short-circuits the switching device Q5 when the voltage induced in the secondary winding S2 is high. The gate drive circuit according to the fourth embodiment opens the switching device Q5 when the voltage induced in the secondary winding S2 is low. Since the gate drive circuit according to the fourth embodiment generates the gate signal for the switching device Q5, not from the voltage monitor shown in FIG. 6, but from the signal from the secondary winding S2, the size of the gate drive circuit according to the fourth embodiment is smaller than the size of the gate drive circuit according to the third embodiment. Switching element Q5 is turned on automatically when the voltage induced in secondary winding S2 is high, which voltage is changeable in accordance with the open-close situation of switch Q1. Thus, the gate drive circuit of FIG. 7 differs from FIG. 5 in that both a diode and the voltage monitor of FIG. 6 are not included, which makes it possible to achieve remarkable size reduction.

The invention is applicable not only to detecting the state of the isolated voltage of the half-bridge-type DC/DC converter as shown in FIG. 1 or the DC/DC converter having one switching device as shown in FIG. 9, but also to detecting the state of the isolated voltage of a full-bridge-type DC/DC converter or an inverter. The gate drive circuit for the half-bridge-type DC/DC converter includes one driving transformer. The gate drive circuit for the full-bridge-type DC/DC converter or for the inverter includes a plurality of driving transformers corresponding to the number of switching devices included in the full-bridge-type DC/DC converter or in the inverter. When the over voltage and the under voltage of the foregoing second power supply (main storage battery 2) is detected, the over voltage or the under voltage of the main storage battery 2 may be transmitted to the control side, which is isolated from the side of the DC/DC converter having the main storage battery 2, by short-circuiting the secondary sides of the transformers or by short-circuiting the secondary side of one of the transformers.

Since the control apparatus for controlling a DC/DC converter according to the present invention transfers the isolated data signal using a conventional driving transformer plus a few semiconductor devices added to the driving transformer, the control apparatus according to the present invention is manufactured for the same or less cost than the manufacturing cost of the conventional control apparatus which employs a photo-coupler. Since the constituent elements of the present control apparatus deteriorate with age slower than the photo-coupler used in the conventional control apparatus, the control apparatus according to the present invention exhibits improved reliability.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A control apparatus for controlling a DC/DC converter having one or more switching devices, the DC/DC converter transferring electric power to a first electric power supply from a second electric power supply, the control apparatus comprising:
a control circuit arranged on a side of the DC/DC converter having the first electric power supply;
a gate drive circuit having a driving transformer; and
a voltage monitor, the voltage monitor monitoring a voltage of the second electric power supply, wherein
the control circuit driving a primary side of the driving transformer and, to induce a voltage on a secondary side of the driving transformer, the driving transformer driving the one or more switching devices arranged on a side of the DC/DC converter having the second electric power supply, isolated from the control circuit, with the induced voltage,
the voltage monitor outputting a signal for short-circuiting the secondary side of the driving transformer when the voltage of the second electric power supply is outside a predetermined range, making a substantially large current flow on the primary side of the driving transformer, and
the control circuit detecting the substantially large current flowing on the primary side of the driving transformer to detect the voltage of the second electric power supply outside the predetermined range on a side of the DC/DC converter having the control circuit.

2. The control apparatus according to claim 1, wherein the secondary side of the driving transformer comprises a plurality of windings and a short-circuiting circuit connected to one of the windings.

3. The control apparatus according to claim 1, wherein the secondary side of the driving transformer comprises a plurality of windings and short-circuiting circuits connected to each of the respective windings.

4. The control apparatus according to claim 1, wherein the secondary side of the driving transformer comprises a plurality of windings, a short-circuiting circuit connected to one of the windings, and one or more additional circuits connected to the other winding or the other windings, the one or more additional circuits not feeding driving electric power to the corresponding one or more switching devices when the voltage induced in the other winding is below a predetermined threshold value or when the voltages induced in the other windings are below a predetermined threshold value.

5. A control apparatus for controlling a DC/DC converter having switching devices, the DC/DC converter transferring electric power to a first electric power supply from a second electric power supply, the control apparatus comprising:
a control circuit arranged on a side of the DC/DC converter having the first electric power supply;
a gate drive circuit having a plurality of driving transformers; and
a voltage monitor, the voltage monitor monitoring the voltage of the second electric power supply, wherein
the control circuit driving primary sides of the respective driving transformers and, to induce voltages on secondary sides of the respective driving transformers, the driving transformers driving the respective switching devices arranged on a side of the DC/DC converter having the second electric power supply, isolated from the control circuit, with the induced voltages,
the voltage monitor outputting a signal for short-circuiting the secondary side of one of the driving transformers when the voltage of the second electric power supply is outside a predetermined range, making a substantially large current flow on the primary side of the one of the driving transformers, the secondary side thereof being short-circuited;
the control circuit detecting the substantially large current flowing on the primary side of the one of the driving transformers to detect the voltage of the second electric power supply outside the predetermined range on a side of the DC/DC converter having the control circuit.

6. A control apparatus for controlling a DC/DC converter having switching devices, the DC/DC converter transferring electric power to a first electric power supply from a second electric power supply, the control apparatus comprising:
a control circuit arranged on a side of the DC/DC converter having the first electric power supply;
a gate drive circuit having a plurality of driving transformers; and
a voltage monitor, the voltage monitor monitoring the voltage of the second electric power supply, wherein
the control circuit driving primary sides of the respective driving transformers and, to induce voltages on secondary sides of the respective driving transformers, the driving transformers driving the respective switching devices arranged on a side of the DC/DC converter having the second electric power supply, isolated from the control circuit, with the induced voltages,
the voltage monitor outputting a signal for short-circuiting the secondary sides of the respective driving transformers when the voltage of the second electric power supply is outside a predetermined range, making substantially large currents flow on the primary sides of the respective driving transformers, the secondary sides thereof being short circuited, and
the control circuit detecting the substantially large current flowing on the primary side of one of the driving transformers to detect the voltage of the second electric power supply outside the predetermined range on a side of the DC/DC converter having the control circuit.

7. The control apparatus according to claim 1, further comprising a latch circuit, the latch circuit latching the signal indicating the detection of the voltage of the second electric power supply outside the predetermined range.

8. The control apparatus according to claim 5, further comprising a latch circuit, the latch circuit latching the signal indicating the detection of the voltage of the second electric power supply outside the predetermined range.

9. The control apparatus according to claim 6, further comprising a latch circuit, the latch circuit latching the signal indicating the detection of the voltage of the second electric power supply outside the predetermined range.

10. The control apparatus according to claim 1, where in the control circuit t stops a converting operation of the DC/DC converter when the voltage of the second electric power supply outside the predetermined range is detected.

11. The control apparatus according to claim 5, where in the control circuit t stops a converting operation of the DC/DC converter when the voltage of the second electric power supply outside the predetermined range is detected.

12. The control apparatus according to claim 6, wherein the control circuit stops a converting operation of the DC/DC converter when the voltage of the second electric power supply outside the predetermined range is detected.
